(19) United States
(12) Patent Application Publication
(10) Pub. No.: US 2023/0302741 A1
(43) Pub. Date: Sep. 28, 2023

(54) METHOD FOR PRODUCING PLASTIC PARTS WITH GLASS INSERTS, AND PLASTIC PARTS WITH GLASS INSERTS

(71) Applicant: LPKF LASER & ELECTRONICS SE, Garbsen (DE)

(72) Inventors: Robin Krüger, Hannover (DE); Oktavia Ostermann, Hannover (DE); Bernd Rösener, Porta Westfalica (DE); Malte Schulz-Ruhtenberg, Wunstorf (DE); Roman Ostholt, Langenhagen (DE); Tobias Jaus, Nürnberg (DE); Anna Kolossowski, Fürth (DE)

(21) Appl. No.: 18/040,231

(22) PCT Filed: Jun. 17, 2021
(86) PCT No.: PCT/EP2021/066449

§ 371 Date: Feb. 1, 2023

(30) Foreign Application Priority Data
Aug. 4, 2020 (DE) 10 2020 209 825.5

(51) Int. Cl. B29C 65/60; B01L 3/00; B29C 65/64; B29C 65/00; C03C 23/00

(52) U.S. Cl. CPC B29C 65/606; B01L 3/5085; B29C 65/64; B29C 66/21; B29C 66/24221; B29C 66/5346; B29C 66/7465; C03C 23/0025; B01L 2200/12; B01L 2300/12

(57) ABSTRACT

The invention provides a process for producing plastic parts, each of which has at least one glass insert which is connected to the plastic part along a connecting region, and the glass insert is free of plastic in the region encompassed by the connecting region and forms a glass window. The connecting region of the glass insert is preferably circumferentially closed. The glass window can have through-holes or preferably recesses extending only over a portion of the thickness of the glass window and having microstructures.

The present invention relates to a process for producing plastic parts having a glass insert by connecting prefabricated plastic parts to a glass insert, e.g. along a recess of the plastic part, so that the glass insert covers the recess. The connection of the plastic part with the glass insert is carried out without a filler material, e.g. without adhesive and without sealant. The plastic part with the glass insert forms a connecting region in which the plastic part is connected to the glass insert in a form-fitting, liquid-tight manner and without filler material.

In a preferred embodiment, at least two glass inserts are integrally contained as sections in a single-pieced glass plate and each covers a recess of the plastic part.

The process has the advantage that the plastic parts are prefabricated and accordingly there e.g. is no injection molding in the process, which could directly affect glass.

### STATE OF THE ART

U.S. Pat. No. 9,236,274 B1 describes the deposition of metal in through-holes in glass plates.

CN 201288133 Y, according to a computer translation, describes the connecting of two glass plates to one another.

US 2016/0165727 A1 describes the enclosure of electrical components between two plate-shaped carriers, which are spaced apart by a frame, with a circumferential sealing ring. This circumferential sealing ring is to be in positive engagement with the two plates.

US 2016/0052202 A1 describes the generation of undercuts in glass by laser irradiation and the subsequent connecting with metals or plastics introduced into the undercut.

DE 10 2019 201 350 A1, published after the priority date of the present application, describes the production of a glass-plastic composite by introducing liquid plastic into recesses in glass.

US 2016/0221254 A1 describes the application of a connecting layer made of plastic by injection molding directly onto glass, which has a porous surface, with subsequent welding of the connecting layer to another part, e.g. made of synthetic resin.

DE 101 55 312 A1 describes the connecting of two workpieces, one of which has through-holes and the other matchingly aligned holes with undercuts, by filling the through-holes and undercuts with plastic.

### OBJECT OF THE INVENTION

The invention has the object of specifying an alternative process for the production of plastic parts having a glass insert, as well as plastic parts which are producible by the process and which have a glass insert. Therein, the plastic parts shall be prefabricated and the process shall be practicable without injection molding on the glass insert. Preferably, the plastic parts producible by the process shall not have an accessible adhesive layer between glass insert and plastic. Further preferably, the plastic part with glass insert shall have no volatile solvent.

### DESCRIPTION OF THE INVENTION

The invention achieves the object by the features of the claims and, in particular, provides a process for producing plastic parts which each have at least one glass insert or a plurality of glass inserts, wherein each glass insert is connected to the plastic part along a connecting region and each glass insert is free of plastic in the region encompassed by the connecting region. The region free of plastic, which region is encompassed by the connecting region, can also be referred to herein as a glass window. The connecting region of the glass insert is preferably circumferentially closed, for example circumferentially closed and arranged directly adjacent to the encompassed glass window. The glass window is preferably a free glass surface, alternatively the glass window can be coated with another mass, e.g. with another plastic or metal. The glass window can have through-holes or preferably recesses extending only through a portion of the thickness of the glass window and having microstructures. The glass insert is preferably completely planar and has a uniform thickness in the connecting region which comprises the through-holes.

The documents cited as prior art do not give any incentive for the process according to the invention of allowing a prefabricated plastic part having a weld bar to pass through the through-holes of an abutment region of a glass insert by warming and pressing the material of the weld bar to form a connecting region encompassing a plastic-free region of the glass insert.

The glass window can have through-holes which are etched into the glass and which has the surface produced by the etching, e.g. pure SiO₂ groups, and which in particular has no coating thereon. Alternatively, through-holes in the glass window can have electrical conductors extending through the through-holes, an organic coating, e.g. with a reactive silane, e.g. one containing methyl silane, with C₁ to C₁₂ aliphatic groups, optionally containing an amino group, at least one carboxylic acid group, e.g. generated by reaction with an organic silane compound (e.g. APTES). Electrical conductors can fill the through-holes. Electrical conductors can be produced by filling the through-holes of the glass, which are arranged in the region of the eventual glass window, with metal or a precursor compound for metal, and warming. Preferably, contact surfaces connected to conductors are produced on the surface of the glass window, which surface lies opposite to the plastic part. Precursor masses for metal can contain, for example, plastic, metal particles or metal oxide particles, and the glass insert, prior to being arranged against the plastic part, can be heated to a temperature at which metal particles melt and/or metal oxide particles are reduced to electrically conductive metal, if necessary in the presence of a reducing atmosphere.

Preferably, the glass insert is liquid-tight in the region encompassed by the connecting region, also referred to as the glass window, e.g., in that the glass window has no through-holes or is closed, and optional through-holes are filled in a liquid-tight manner, e.g., by one electrical conductor each. Optionally, the glass insert has at least one flat and self-contained surface, or both of the surfaces lying opposite to one another are flat and self-contained.

Optionally, the glass insert in the region encompassed by the connecting region has recesses that extend only over a portion of the thickness of the glass insert, such that the depth of the recesses into the glass insert is only a portion of the thickness thereof and, therefore, the recesses have a bottom formed as one piece in the glass substrate.

Generally preferably, through-holes and optional recesses extending only over a portion of the thickness of the glass insert are produced by spot irradiation of the glass insert with laser radiation and subsequent etching. The spot irradiation of laser radiation is achieved by focusing the laser radiation on a point with a size of a few micrometers, e.g. 1 to 10 μm or up to 5 μm. Therein, it is advantageous if the focus of the laser radiation extends over a length along the direction of propagation of the laser beam that is substantially greater than the Rayleigh length of a corresponding laser beam having a Gaussian profile. This can be achieved by suitable optical devices, e.g. diffractive optical elements. The irradiation can be a penetration by irradiation, or an irradiation can occur less deep into a first thickness portion of the glass insert adjacent to the first surface, e.g., by the focus of the laser radiation in the direction of the propagation direction of the laser radiation not extending across the entire thickness of the glass insert. Since an interaction between laser radiation and material of the glass plate occurs only in the focus, it is thus possible to let the interaction region end within the first glass plate. Preferably, the laser radiation consists of laser pulses.

Optionally, a first surface of the glass insert is not coated and a second surface of the glass insert is coated throughout with etch resist to prevent the formation of recesses from the second surface along the irradiated laser beams. Thereby, likewise the shape of the cross-section of the recesses can be changed, for example, to a V-shaped or frustoconically tapering cross-section. Alternatively, the laser beam during irradiation can be controlled so that the intensity is only sufficient to traverse a portion of the thickness of the glass insert in order to modify the glass insert along the light path, e.g., by adjusting the distance of the focal position relative to the first surface of the glass insert.

Generally optionally, during etching, the second surface of the glass insert is coated throughout with etch resist to prevent the formation of recesses from the second surface along the irradiated laser beams. Thereby, likewise the shape of the cross-section of the recesses can be changed, for example, to a V-shaped or frustoconically tapering cross-section. Alternatively, upon irradiation the laser beam can be controlled so that the intensity is only sufficient to traverse a portion of the thickness of the glass insert in order to modify the glass insert along the light path, e.g., by adjusting the distance of the focal position relative to the first surface of the glass insert.

The diameter of the recesses or resp. of the through-holes is adjustable by the reaction conditions and the duration of the etching, since the etching occurs concentrically around the linear path taken by the irradiated laser beam through the glass insert. The walls located between recesses, in particular between through-holes in the contact region, terminate in a common plane. The end faces of these walls lie in a common plane and form the first surface or form the first surface in a common plane, the first surface being interrupted by the recesses. Preferably, the first surface is interrupted only by the cross-sections of the recesses.

The laser beam is preferably pulsed at each of the locations at which it is irradiated onto the glass insert, e.g. with a wavelength of 1064 nm, preferably with pulse lengths of at most 100 ps or at most 50 ps, preferably at most 10 ps. Generally, the laser is set up so that the laser beam does not impinge on the glass insert between the locations where a recess or through-hole is to be etched. Preferably, the laser beam is irradiated in a point-shaped manner and in perpendicular to the surface of the glass insert. Preferably, this surface onto which the laser beam has been irradiated forms the first surface of the glass insert. The etching is e.g. carried out with hydrofluoric acid, e.g. 1 to 48 wt.-%, and/or sulfuric acid and/or hydrochloric acid and/or phosphoric acid and/or nitric acid, or potassium hydroxide solution, at e.g. up to 140° C.

The glass insert can e.g. have a thickness prior to etching of up to 1000 μm, preferably 100 to 1000 μm, e.g., up to 800 μm, e.g., 300 to 500 μm; after etching, a thickness reduced by 50 to 700 μm, e.g. reduced by up to 200 μm.

Optionally, etching of the glass insert is terminated when the recesses in the glass window extend over only a portion of the thickness of the glass insert such that the depth of the recesses in the glass insert in the glass window is only a portion of the thickness thereof and, therefore, the recesses have a bottom formed as one piece in the glass insert.

The recesses preferably extend at an angle of e.g. 0° to 15° in a conical or frustoconical taper and starting from the surface of the first glass plate into its volume.

Optionally, in general, the glass insert can be subjected to etching without a coating, e.g., without a mask and/or without etch resist, so that the process has the advantage of being carried out without applying and without removing etch resist from the glass insert. Generally, at least the first surface of the glass insert remains without etch resist and without mask and is etched without etch resist.

Generally optionally, the second surface of the glass insert is completely coated with etch resist, optionally only in the area of the glass window, so that the etching is performed only from the first surface, or the laser which irradiates the laser beam is configured so that the laser beam traverses only a portion of the thickness of the glass insert in the area of the glass window, or so that the laser beam ends in the glass window within the thickness of the glass insert. In this embodiment, each position of the glass insert in the area of the glass window, at which position a recess is to be generated, is optionally irradiated with laser beams in a point-shaped manner at a plurality of positions spaced apart from one another, for example at at least 3 or at least 10 or at least 30 positions, wherein preferably the laser beams are irradiated in parallel to one another and in perpendicular to the glass window, successively or simultaneously. The positions form the location at which the etching removes the glass insert faster than at surface areas distant therefrom. The positions where the laser was irradiated during etching lead to a uniformly fast removal of the glass and optionally together form a recess. The positions which are irradiated in the area of a spot and which form a spot are arranged, for example, at a spacing of 1 to 10 μm. Preferably, the positions are arranged within the area around each spot, in which area a recess is to be formed in each case. Preferably, the positions at which laser beams are irradiated around a spot or are irradiated to form a spot are arranged at a spacing of 1 to 10 μm, e.g. 2 to 5 μm or up to 3 μm, which is determined in particular in the plane of the first surface of the glass insert.

In general, a recess can be generated by a single laser pulse or by multiple laser pulses. In the case of a single laser pulse, the diameter of the recess is determined primarily by the etching duration. When a recess is generated by multiple laser pulses, the diameter of the recess is determined by the number and spacing of the positions at which laser beams are irradiated for a spot and penetrate the glass insert in the area of the glass window. The depth of the recess in the volume of the glass insert can be determined by the duration of etching and by the laser beam penetrating the glass insert only to a proportion, resp. the laser beam does not penetrate the glass insert completely.

In this embodiment, the bottom of the recesses in the glass window can have microstructures that are set up for near-field illumination of the interior volume of the recesses. Such microstructures can, for example, take the form of narrow, tall glass peaks and thus can act as optical waveguides for the illumination or can affect individual cells or collections of cells in their position or orientation. Such structures can e.g. be produced by forming a recess by etching a plurality of positions at which laser pulses have been irradiated in a closely spaced manner. If a single laser pulse is omitted in the center of the recess, a glass tip will remain standing here within the recess after the etching process. In general, a recess can be generated in the process by irradiating laser pulses next to one another at positions, and subsequent etching, wherein the positions are arranged at equal distances from one another of at most 10 μm, e.g. 1 to 5 μm or up to 3 μm, and together form a spot, wherein at least 2 or at least 3 positions are arranged at a greater distance, e.g. at a distance of 10 to 30 μm, e.g. 15 to 20 μm distance. The at least 2 or 3 positions of the laser pulses arranged at a greater distance have between them, for example, the region in which a laser pulse is omitted at the same spacing, or surround the region in which a glass tip remains standing during etching.

Generally, laser pulses can be irradiated to different depths into the glass insert at positions that form a spot where a recess is formed by etching. Thus, for example, laser pulses at positions near the glass window can be irradiated deeper into the thickness of the glass insert and penetrate deeper, and other laser pulses at positions can be irradiated less deeply into the thickness of the glass insert. During the subsequent etching, deeper or further recesses are formed at positions where laser pulses were irradiated deeper into the glass insert, and at positions where laser pulses were irradiated less deeply into the glass insert, the bottom of the recess is formed at a lesser depth. In general, depending on the spacing of the positions, a concave depression in the bottom can be formed at each position. A recess having a bottom and further deeper recesses therein can be produced by irradiating laser pulses in the part of the positions that are to form the bottom to less depth in the glass insert, and in the part of the positions that are to form further recesses extending from the bottom deeper into the first glass plate irradiating laser pulses deeper into the glass insert, and subsequent etching. For a larger diameter of further recesses extending deeper into the glass insert in the area of the glass window starting from the bottom of a recess, laser pulses irradiated deeper into the glass insert can be arranged at adjacent positions, e.g. at a distance of 1 to 10 μm, e.g. 2 to 5 or up to 3 μm, so that at these positions etching in the area of the glass window penetrates deeper into the glass insert. In this way, laser pulses can be irradiated less deeply into the glass window at a portion of the positions, and laser pulses can be irradiated more deeply into the glass window at a portion of the positions, so that during etching at the positions where the laser pulses have been irradiated less deeply, a bottom with concave depressions at a lesser depth is produced, and at the positions where laser pulses have been irradiated more deeply, further recesses are produced which extend more deeply into the glass insert in the area of the glass window.

In this embodiment for the production of glass inserts having recesses in the area of the glass window encompassed by the connecting region, which recesses extend only into a portion of the thickness of the glass insert and do not form through-holes, the etching is carried out for a period of time sufficient to achieve a desired depth of the recesses in the glass volume of the glass window, which depth is at a distance from the second surface, or resp. etching is carried out only for a period of time after which the glass insert still has a closed second surface. Optionally, therein, the bottom of the recesses can have concave depressions having a parabolic or conical cross-section. Such concave depressions can be formed at any position where a laser beam has been irradiated in a spot-shaped manner. Preferably, such concave depressions have a cross-sectional opening and a depth of a few micrometers, e.g., 1 to 5 μm.

The recesses in the area of the glass window have e.g. a depth of at least 40 μm, at least 50 μm or at least 100 μm or at least 150 μm, e.g. up to 250 μm or up to 200 μm. The recesses have, for example, a diameter of at least 10 μm or at least 30 μm, e.g. up to 200 μm or up to 1 mm, generally preferably with an aspect ratio of depth to diameter of at least 2, at least 4, at least 5 or at least 6. The recesses in the area of the glass window have, for example, an internal volume within the glass insert of 1 pL to 1 μL.

Recesses in the area of the glass window, which extend only over a portion of the thickness of the glass insert and form microstructures, have, for example within the glass window, a flat bottom extending approximately in parallel to and at a distance from the surface (closed second surface) of the glass insert, which surface lies opposite to the recess, or have a V-shaped cross-section, preferably rotationally symmetrically conical tapering to a pointed bottom, or, preferably at a large aspect ratio, a cross-section tapering with increasing depth in the glass insert, merging into a tapered bottom, conical or round or arcuately concave. The large aspect ratio is, for example, an aspect ratio of depth to diameter, measured in the plane of the first surface from which the recess extends into the glass insert, of at least 2, at least 4, at least 5, or at least 6. The recesses have, for example, an internal volume within the glass insert of 1 pL to 1 μL. Generally, microstructures have a cross-section that tapers with increasing depth in the glass insert.

The process comprises or consists of the steps of
providing a plastic part having at least one weld bar lying in a plane, which weld bar preferably encompasses a recess in the plastic part and which is optionally circumferentially closed,
providing at least one glass insert having at least one circumferentially closed abutment region in which spaced through-holes are arranged and which has a shape and size matching the weld bar or consists of spaced through-holes arranged in the abutment region,
arranging the glass insert having the at least one abutment region matchingly to the at least one weld bar of the plastic part,
warming the weld bar and pressing the at least one abutment region of the glass insert against the at least one weld bar of the plastic part to produce a connecting region in which plastic rests solely on the abutment region and has passed through the through-holes of the glass insert, and the connecting region encompasses a plastic-free region of the glass insert.

Preferably, the weld bar is integrally formed on the plastic part and the weld bar encompasses a recess in the plastic part. The recess can be open in a plane opposite to the weld bar and form a passage opening, or it can be closed opposite to and at a distance from the weld bar and form, for example, a blind hole in the plastic part. Preferably, the recess of the plastic part encompassed by the weld bar is covered by the plastic-free region of the glass insert, also referred to as the glass window, and the connecting region encompasses the recess. Preferably, the plastic of the weld bar with the abutment region of the glass insert forms the connecting region, and the glass window encompassed by the connecting region covers the recess of the plastic part encompassed by the connecting region. Generally, a weld bar is an area on the plastic part, preferably an area integral with the plastic part, that protrudes and has a volume that, when heated, passes through the through-holes of the abutment region and forms the connecting region and optionally after exiting forms a flat-pressed layer on the surface of the glass insert, which surface lies opposite to the plastic part. A weld bar can protrude over a surface of the plastic part which, for example, abuts the glass insert after the weld bar is heated and the connecting region is formed from the weld bar.

The glass insert has a uniform thickness, e.g. in the range of 100 to 1000 μm, preferably 200 to 500 μm, e.g. 350 to 450 μm.

The production process has the advantage that in the connecting region plastic which has passed through the through-holes of the abutment region on the surface of the glass insert opposite to the plastic part forms protrusions, preferably a flat-pressed layer of plastic on the glass insert. This is because such protrusions, or a layer of plastic produced therefrom by flat-pressing, form a spacer to the glass insert, so that when the plastic part is set down with the glass insert facing a flat base, the glass insert does not rest directly on the base. Therein, the layer of plastic that forms a spacer to the glass insert on the glass surface lying opposite to the plastic part can be produced by flat-pressing plastic that exits through through-holes on the surface of the glass insert, which surface lies opposite to the plastic part, to form a layer that extends to a common plane at a distance from the surface of the glass insert.

The glass insert is preferably arranged in one plane when its abutment regions are arranged against the weld bar of the plastic part and during pressing against it. Accordingly, the glass insert or the at least one glass window formed by the glass insert, inclusive of its abutment region is arranged in one plane, in particular is not bent.

The connection of the glass insert to the plastic part generated by the process along the connecting region exclusively consists of the plastic of the weld bar that is solidified after the warming and abuts the glass insert exclusively in the abutment region and extends through the through-holes of the glass insert. It has shown that the connecting region formed in this way, which consists of the plastic of the weld bar and the contact region of the glass insert, is liquid-tight without additional material, e.g. without adhesive. Therefore, the connecting region consists of plastic of the plastic part, in particular of the plastic of the weld bar, which has passed through the through-holes of the contact region of the glass insert, and of the contact region of the glass insert.

Optionally, on a plastic part, which is preferably single-pieced, and which has at least two circumferentially closed weld bars, a glass insert with its abutment region matching the weld bar is arranged on each weld bar and is connected to the plastic part by warming the weld bar and pressing the glass insert with its abutment region against the weld bar to produce a connecting region.

Generally, at least two glass inserts, each having a circumferentially closed abutment region in which spaced through-holes are arranged, can be contained as sections in a single-pieced glass plate. In this embodiment, a single-pieced glass plate containing as sections at least two glass inserts, each having an abutment region, is arranged against one plastic part or against at least two plastic parts, each having at least one weld bar, preferably a weld bar for each abutment region, wherein an abutment region is arranged to match a weld bar in each case. During subsequent warming of the weld bar, preferably of all weld bars simultaneously, and pressing of the glass plate against the one plastic part or against at least two plastic parts, connecting regions are produced in each case from the abutment regions and weld bars. Subsequently, optionally, the glass plate and/or the one or the at least two plastic parts can be cut between adjacent connecting regions into sections, each having at least one plastic part and at least one glass insert and connected to one another by at least one connecting region. Generally preferably, the at least one plastic part and the at least one glass insert are connected to one another exclusively by at least one connecting region consisting of the plastic of weld bars abutting the abutment region of the glass insert and extending through the through-holes of the abutment region, preferably to beyond the surface of the glass insert, which surface lies opposite to the plastic part, wherein further preferably the plastic part is single-pieced.

Generally, glass inserts contained as sections in a single-pieced glass plate are integral regions of the glass plate. Generally, the abutment region that is circumferentially closed and with a weld bar forms a respective connecting region around a recess of the plastic part and forms a glass window over the recess can be referred to as a first abutment region.

Generally, the plastic part can have at least one foot that projects beyond the plane in which the weld bar is attached to the plastic part, plus the thickness of the glass insert and the height of the plastic that opposite to the plastic part in the connecting region has exited the through-holes of the glass insert. Preferably, the foot is formed in one piece with the plastic part. Further preferably, the foot forms a circumferential edge around the plastic part.

In one embodiment, the plastic part has at least 2, e.g. 96, 384 or a multiple thereof, recesses, each with an integrally formed weld bar, and an equal number of glass inserts, each with an abutment region or resp. first abutment region, is contained as sections in at least one, preferably in exactly one, single-pieced glass plate, and further preferably the plastic part has a second weld bar extending along its circumferential outer edge and the glass plate has a second abutment region along its circumferential outer edge in which spaced-apart second through-holes are arranged. The at least one glass plate is arranged with the abutment regions of the glass inserts contained as integral sections matching the weld bars of the plastic part, and with its second abutment region matching the second weld bar of the plastic part extending along the circumferential outer edge. In this embodiment, upon warming the weld bars and pressing the glass plate against the plastic part, a second connecting region is produced from the second abutment region and the second weld bar in addition to the individual connecting regions of the glass inserts. Therein, the through-holes in the second abutment region can have a larger diameter and/or larger distances from one another than the through-holes of the first abutment regions. Preferably, second weld bars contain more plastic per length than first weld bars.

Preferably, in the second connecting region, the plastic passing through the second through-holes is pressed against the glass plate along second abutment regions, further preferably, the plastic passing through is molded around the circumferential outer edge of the glass plate until the plastic covers at least the circumferential outer cross-sectional surface of the glass plate.

The second through-holes, which are arranged in the second abutment region running along the outer edge, can have the same diameter as the through-holes in the abutment region, preferably the second through-holes have larger diameters, e.g. larger than the through-holes in the abutment region by at least a factor of 1.5 or at least 2. Preferably, the second weld bar has a larger volume than the weld bars that are arranged matching the abutment regions. Generally, each weld bar can consist of exactly one weld bar or of at least two partial weld bars, which e.g. run in parallel to one another. A weld bar or partial weld bar can project, for example, by 0.1 mm to 1 mm or up to 0.5 mm over an adjacent plane of the plastic part, which plane e.g. encompasses a recess in the plastic part. Optionally, a weld bar or partial weld bar can have interruptions. Generally preferably, all weld bars are warmed simultaneously. The warming of the weld bars can be carried out by irradiation with a laser, e.g. irradiating laser radiation through the glass onto the weld bars. Alternatively, the warming of the weld bars can be carried out by warming the glass insert, in particular the glass plate, e.g. in a furnace, and pressing the warmed glass insert or the warmed glass plate against the plastic part.

The flat-pressing of plastic exiting opposite the plastic part through first and/or second through-holes can be carried out by means of a punch, which is preferably set up to move such plastic into a predetermined distance away from the glass insert and optionally away from the glass window, and is optionally set up to cover the glass window.

Weld bars, optionally the entire plastic part, are e.g. made of polystyrene, polypropylene, polyurethane or polycarbonate. Optionally, the plastic part consists integrally of plastic, which can be colored, which is impermeable to optical radiation.

Through-holes are preferably generated by treating a glass insert with laser pulses at the spots where recesses are to be generated, and subsequently etching the glass. This is because laser pulses generate modifications, e.g. structural changes, in the glass that are dissolved more quickly during the subsequent etching than areas that are not laser-irradiated. Laser pulses having a wavelength at which the glass has high transmission, for example a wavelength of 1064 nm, are suitable for glass, e.g. with pulse lengths of at most 100 ps or of at most 50 ps, preferably at most 10 ps. The laser source is operated in pulsed mode, the laser beam is moved over the glass in sections or with interruptions. The distance of the pulses irradiated onto the glass is set via the pulse frequency and the speed of movement of the laser beam over the glass carrier.

The through-holes in the glass, at least a portion of which through-holes are optionally inclined to one another and/or are not in parallel to one another and/or are inclined to the perpendicular, and which through-holes extend between the opposing and parallel surfaces of the glass, can be generated by treating the glass with laser pulses at an angle less than 90° to the surface and subsequent etching. The through-holes through the glass, which are inclined to one another and are not in parallel, are suitable for producing a glass-plastic composite that forms the connecting region.

The glass is flat and prior to the irradiating with laser pulses and prior to the etching has, for example, a thickness of up to 800 μm, preferably 100 to 800 μm, e.g. 300 to 500 μm, after etching has e.g. a thickness reduced by 50 to 700 or by up to 200 μm, and through-holes in the laser-irradiated areas. During the production of the through-holes by means of laser pulses and subsequent etching, such through-holes can be substantially cylindrical, e.g. tapering with a small angle, e.g. from 3° to 15° , from the surface of the glass into the glass volume. The through-holes can have a cross-section with an hourglass shape through the thickness of the glass insert, in which the diameter decreases along the thickness of the glass insert toward the center, e.g. in a funnel shape, and widens in a funnel shape from the center to the opposite surface. Thereby, a region of smallest cross-section of the recess is formed within the thickness of the glass insert. This region of smallest cross-section forms a preferred undercut. Therein, the slope of the funnel shape can run approximately linearly in each case.

The through-holes can e.g. have, measured in the plane of a surface of the glass insert, a cross-section in the range from 10 μm to 1 mm, e.g. from 20 or from 50 μm to 800 μm or to 700 μm, to 600 μm, to 500 μm, to 400 μm or 300 μm or to 200 μm or to 100 μm, in each case +50 μm and/or −50 μm. Generally preferably, glass inserts in the abutment region have a plurality of through-holes, e.g. at least 10, at least 20, at least 100 or at least 200 recesses, e.g. over a stretch of at least 1 cm or at least 2 cm each, e.g. over 2 to 20 cm or up to 10 cm. Generally, recesses can be arranged with a spacing of 0.2 to 2 mm, e.g. over a stretch of at least 1 cm or at least 2 cm, e.g. over 2 to 20 cm or up to 10 cm.

The through-holes preferably have at least one undercut within the thickness of the glass insert. Optionally, an additional undercut can be formed by the surface opposite to which the plastic part is arranged against the glass insert.

An undercut is formed by the through-holes widening within the glass insert, in particular widening in the direction towards the surface of the glass insert that is opposite to the surface onto which the plastic part is pressed. Alternatively or additionally, an undercut can be formed by the through-holes tapering and then widening, e.g. each in a conical manner. Conically tapering through-holes extending from the surface into a glass are formed by etching a glass insert along the locations irradiated with laser pulses, because the etching reaction progresses from the glass surface into the glass volume along the irradiated spots and therefore has a longer exposure time near the glass surface. Since the etching reaction acts on all, or on both opposite, surfaces of the glass insert, the result is a cross-section tapering from the surface of the glass insert, e.g. to a minimum cross-section that lies between the surfaces of the glass insert and widens to the opposite surface.

The through-holes are e.g. arranged with a spacing that is at least 10%, at least 20%, or at least 50%, or at least 200% of the diameter of the through-holes measured in the plane of a surface of the glass insert. The spacing can be, for example, up to 20 times or up to 15 times or up to 10 times, for example, up to 200% or up to 100% or up to 50% of the diameter of one of the through-holes, measured in the plane of a surface of the glass insert.

The weld bar can e.g. consist of a thermoplastic which is warmed to a temperature above its glass transition temperature or above its melting temperature. The warming can be carried out, for example, by laser irradiation of the weld bar and/or by applying ultrasound, for example by ultrasonic welding, optionally simultaneously with or prior to pressing the plastic part against the glass insert. Alternatively, the plastic of the weld bar can be a thermoset against which the glass insert is pressed prior to or during its curing. Optionally, the curing of a thermoset can be initiated by irradiation, for example with UV radiation, which is optionally laser radiation.

Optionally, additionally, ultrasonic vibrations can be applied to the glass insert and/or to the solidifying plastic.

It has shown that thermoplastics or curable blends that react to form thermosets can have a sufficiently low viscosity to be drawn into through-holes that pass through the glass insert, e.g. into recesses having a diameter of 5 to 100 μm, e.g. 10 to 20 μm, by capillary forces and/or when pressing the glass insert against the plastic part. The pressure can be a positive pressure by which the solidifying plastic is pressed against the glass insert, and/or negative pressure which draws the plastic of the weld bar into the through-holes from the surface of the glass insert, which surface lies opposite to the plastic part, through the through-holes. Optionally, while the glass insert is pressed against the plastic part, the plastic is pressed into the through-holes until the plastic of the weld bar encompasses at least one undercut of the through-holes, preferably until the plastic of the weld bar exits through the through-holes on the surface of the glass insert, which surface lies opposite to the plastic part.

The solidification of the plastic can e.g. be carried out by cooling if the plastic is a thermoplastic, or by reactive curing if the plastic is a thermoset.

It has shown that the glass-plastic composite forming the connecting region is a form-fitting connection in which the plastic is arranged on the surface and in the through-holes of the glass insert. The surfaces of the plastic and glass insert that lie on top of one another in the connecting region even in small dimensions have sufficient surface area to be liquid-tight. The through-holes formed through the glass have the advantage that the undercuts formed within the through-holes form a positive and liquid-tight connection with the plastic inserted therein. Therein generally, the plastic can exhibit a different expansion behavior upon temperature changes than the glass. When the plastic expands to a lesser extent than that of the glass insert, the plastic preferably pulls more strongly into the e.g. conical through-holes; when the plastic expands to a greater extent than that of the glass, the plastic preferably presses more strongly in perpendicular against the wall of the e.g. conical through-holes.

The invention is now described in more detail with reference to the figures, which show schematically in

FIG. 1 A) to D) embodiments of recesses in the glass window of the glass insert in cross-section in perpendicular to the surface,

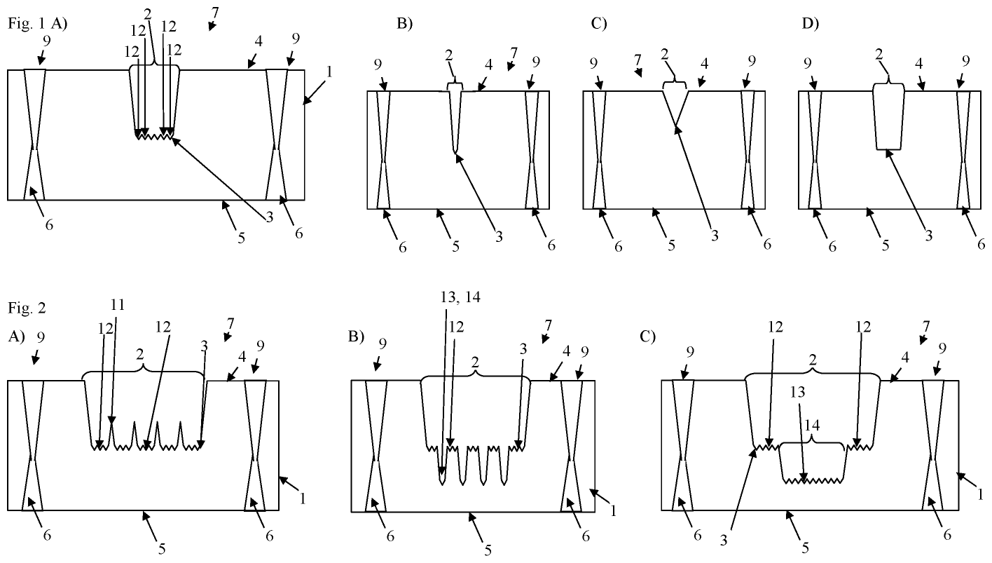

FIG. 2 A), B), C) further embodiments of glass inserts in cross-section in perpendicular to the surface of the first glass plate,

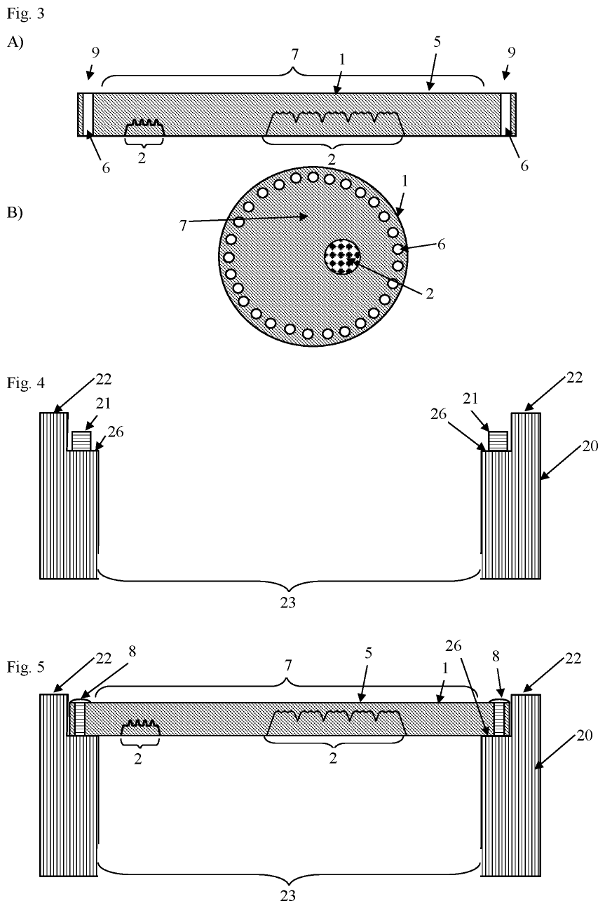

FIG. 3 A) a glass insert in cross-section, in B) the glass insert in reduced view in elevation,

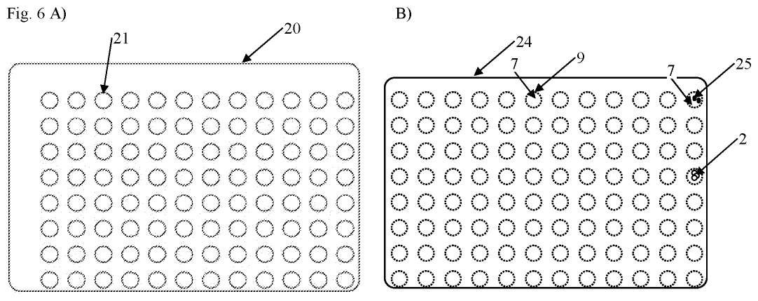

FIG. 4 a plastic part in cross-section,
FIG. 5 a plastic part with glass insert, and in
FIG. 6 A) a plastic part of an embodiment and FIG. 6 B) a glass plate having a plurality of glass inserts contained therein.

FIG. 1 A) in a glass insert 1 shows a recess 2 which is producible by etching a glass insert 1 in the area of the glass window 7 after irradiation with a pulsed laser beam. Therein, the bottom 3 shows concave depressions having an approximately parabolic cross-section. Such concave depressions are formed at each position 12 at which a laser beam has been irradiated in a point-like manner. Presently, a bottom 3 having concave depressions is obtained by spot irradiation of laser beams at positions 12 with a spacing corresponding to the spacing of the centers of the depressions. By the etching, which occurs subsequently to the irradiation, the areas of the first glass plate 1 between positions 12 are removed. For this single-pieced embodiment, the laser beam irradiated onto the first surface 4 of the glass insert 1 can be configured to penetrate only up to a portion into the volume of the glass insert 1, and/or the second surface 5 lying opposite to the first surface 4 can be coated with etch resist over its entire surface. A row of through-holes 6 is arranged along the circumference to form an abutment region 9.

FIG. 1 B) shows a recess 2 having a large aspect ratio with a cross-section tapering with increasing depth in the glass insert, ending in a tapered bottom, conical or round.

FIG. 1 C) shows a recess 2 having a V-shaped cross-section, which can be rotationally symmetrically conical or elongated trench-shaped, tapering to a pointed bottom.

FIG. 1 D) shows a recess 2 having a flat bottom extending approximately in parallel to and at a distance from the second, closed surface 5 of the glass insert, which surface lies opposite to the recess.

FIG. 2 shows embodiments of a glass insert whose glass window 7 is encompassed by through-holes 6 that form an abutment region 9. In the glass insert 1 is a recess 2 produced single-pieced in the area of the glass window 7. This shows that irradiating laser pulses onto the first surface 4 of the glass insert at a plurality of positions which are spaced apart by, for example, 1 to 10 μm and therefore form one spot, with subsequent etching produces exactly one recess 2. Therein, a concave depression 12 can be produced by the etching at each position 12 on the bottom 3 of the recess 2.

As shown in FIG. 2 A), a glass tip 11 projecting in perpendicular to the first surface 4 from the bottom 3 into the recess 2 is produced during etching if at least 3 positions 12 at which laser pulses are irradiated are arranged at a greater spacing, e.g. at a spacing of 20 μm. Therein, each position 12 at which a laser pulse was irradiated results in a concave depression in the bottom 3 during etching.

FIG. 2 B) shows that laser pulses, which are irradiated at individual positions 13 and which penetrate deeper into the thickness of the glass insert 1, form further recesses 14 there during etching, which recesses 14 extend deeper into the glass insert 1 than the depression at other positions 12 where laser pulses were irradiated to a lesser depth into the glass insert 1. The depth of penetration of the laser pulses into the glass insert 1 can be predetermined by adjusting the focus position and/or the strength of the pulse energy of the laser pulses.

FIG. 2 C) shows that the irradiation of laser pulses penetrating deeper into the glass insert 1 at side-by-side positions 13 during etching forms another recess 14 there which extends deeper into the thickness of the glass insert 1 than the recess whose bottom 3 is formed during etching of other positions 12 where the laser pulses have been irradiated less deeply into the glass insert 1.

FIG. 3 shows a glass insert 1, along the circumference of which an abutment region 9 with spaced-apart through-holes 6 is formed and in which exemplary recesses 2 are etched in the area of the glass window 7 encompassed by the abutment region 9. The exemplary recesses 2 are shown in sectional view in FIG. 3 A), schematically in plan view in FIG. 3 B).

FIG. 4 shows a prefabricated plastic part 20 having an integrally formed weld bar 21 that is surmounted by a foot 22, which is also integrally formed and which surrounds the recess 23. The recess 23 passes through the thickness of the plastic part 20 at least in sections, preferably over its entire cross-section. The weld bar 21, as is generally preferred, circumferentially encompasses the recess 23. Further, FIG. 4 shows that generally a weld bar 21 can protrude over a surface 26 of the plastic part 20 which, after warming of the weld bar and which, after forming the connecting region 8 from the material of the weld bar 21, abuts the glass insert 1. Generally preferably, the surface 26 lies in a plane that is lies at a distance from and in parallel to the plane in which a foot 22 extends.

FIG. 5 shows that after warming the weld bar 21, its plastic flows through the through-holes 6 and forms the connecting region 8 by which the abutment region 9 or the through-holes 6 of the glass insert 1 is positively connected to the plastic part 20. The recesses 2, each extending only through a portion of the thickness of the glass insert 1, and correspondingly the first surface 4 of the glass insert 1 from which the recess 2 extends into the glass insert 1, face the recess 23 of the plastic part, and correspondingly is accessible from the recess 23 or from the cross-sectional opening thereof.

FIG. 6 A) shows a plastic part which is single-pieced and in 8 rows has 12 continuous breaches each, each of which is encompassed by a circumferential weld bar 21. FIG. 6 B) shows a single-pieced glass plate with an arrangement of abutment regions 9 consisting of through-holes arranged here in a circle-shaped manner. The arrangement of the abutment regions 9 and their sizes correspond to the arrangement and sizes of the weld bars 21 of the plastic part, so that the abutment regions 9 can be aligned matching one weld bar 21 each and can be pressed against it to form the connecting regions. The glass plate 24 has a uniform thickness and contains the plurality of glass inserts in one piece, so that only the abutment region 9 consisting of through-holes 6 and the optional recesses 2 or resp. microstructures 2 contained in the glass window 7 encompassed by the abutment region 9, or through-holes 25 filled by electrical conductors are visible from each glass insert 1.

1. A process for producing a plastic part having a glass insert, comprising the steps of:
providing a prefabricated plastic part having at least one circumferential weld bar lying in a plane,
providing a glass insert having at least one circumferentially closed abutment region in which spaced-apart through-holes are arranged and which has a shape and size matching the weld bar,
arranging the glass insert with the at least one circumferentially closed abutment region matched against the weld bar,
warming the weld bar and pressing the at least one circumferentially closed abutment region against the weld bar to produce a connecting region in which plastic lies in the at least one circumferentially closed abutment region and has passed through the through-holes, and wherein the connecting region encompasses a plastic-free region of the glass insert.

2. The process according to claim 1, wherein at least one recess, which extends only over a portion of the thickness of the glass insert, is produced by spot irradiation with laser radiation and subsequent etching in the plastic-free region, which is surrounded by at least one circumferentially closed abutment region.

3. The process according to claim 2, wherein the plastic part, in the area encompassed by the circumferential weld bar, comprises a recess that passes through the plastic part and is covered on one side by the plastic-free region.

4. The process according to claim 3, wherein the glass insert is arranged towards the recess extending through the plastic part.

5. The process according to claim 4, comprising irradiating laser pulses onto the area of the glass insert encompassed by the at least one circumferentially closed abutment region and subsequently etching the glass insert until the at least one recess comprises a flat bottom extending approximately in parallel to and at a distance from a second surface of the glass insert, which second surface lies opposite to the at least one recess, or a V-shaped cross-section tapering to a pointed bottom, or, in the case of a large aspect ratio, a cross-section tapering with increasing depth in the glass insert, merging into a tapering bottom, conical or round.

6. The process according to claim 1, wherein the weld bar is formed in one piece and has a foot formed in one piece which projects beyond the weld bar by at least a thickness of the glass insert.

7. The process according to claim 1, wherein at least two glass inserts, each having at least one circumferentially closed abutment region, are contained as integral sections in a single-pieced glass plate, which is arranged against the plastic part which has a weld bar for each abutment region, wherein a circumferentially closed abutment region is arranged each matching a weld bar.

8. The process according to claim 1, wherein the plastic-free region of the glass insert comprises flat, closed surfaces on both sides.

9. The process according to claim 1, wherein the plastic-free region comprises through-holes filled by electrical conductors.

10. (canceled)

11. The process according to claim 1, wherein the glass insert is flat and the through-holes are generated by irradiating the glass insert with laser pulses and subsequent etching, wherein the glass insert prior to irradiation with laser pulses and prior to etching comprises a thickness of up to 800 μm, and after etching has a thickness which is smaller by 50 to 200 μm and the through-holes are located only in the laser-irradiated regions.

12. The process according to claim 7, wherein the glass plate comprises a second weld bar extending along its circumferential outer edge, and the glass plate along its circumferential outer edge has a second circumferentially closed abutment region in which spaced-apart second through-holes are arranged, wherein the glass plate is arranged with the abutment regions of the glass inserts contained as integral portions matching the weld bars of the plastic part, and is arranged with its second abutment region matching the second weld bar extending along the circumferential outer edge of the plastic part so that upon warming of the weld bars and pressing the glass plate against the plastic part a second connecting region is produced from the second abutment region and the second weld bar.

13. The process according to claim 1, wherein the plastic is flat-pressed into a layer extending into a plane at a spacing from the surface of the glass insert.

14. The process according to claim 1, wherein the connecting region consists of plastic of the plastic part and the glass insert.

15. A plastic part comprising a glass insert connected to the plastic part along a connecting region extending around a respective recess, wherein the plastic part consists exclusively of plastic that is solidified and is formed as a single piece with the plastic part, wherein the plastic abuts the glass insert exclusively in the connecting region and extends through through-holes formed in the connecting region, wherein the connecting region encompasses a plastic-free region of the glass insert which has flat, closed surfaces on both sides.

16. The plastic part according to claim 15, comprising at least one recess in the plastic-free region of the glass insert, the at least one recess extending only over a portion of the thickness of the glass insert and facing the respective recess in the plastic part.

17. The plastic part according to claim 15, comprising at least two glass inserts, each comprising through-holes in a connecting region, the at least two glass inserts being integrally contained in a single-pieced glass plate which is connected to a plastic part along the connecting region, the at least two glass inserts comprising plastic-free regions that each cover a recess of the plastic part.

18. The plastic part according to claim 17, wherein the glass plate along its circumferential outer edge comprises a second abutment region having spaced-apart second through-holes, and the plastic part along its circumferential outer edge with said second abutment region forms a second connecting region in which plastic formed as a single piece with said plastic part abuts and extends through the second through-holes to the surface of the glass plate, which surface lies opposite to the plastic part.

19. The plastic part according to claim 15, wherein plastic which has emerged through through-holes on the surface of the glass insert, which surface lies opposite to the plastic part, is flat-pressed into a layer extending into a plane at a spacing from the surface of the glass insert.

20. The plastic part according to claim 15, comprising a foot which is formed as a single piece with the plastic part and which is arranged along the circumferential edge of the plastic part and which projects beyond plastic that has emerged from the through-holes of the glass insert.
